(19) United States
(12) Patent Application Publication
(10) Pub. No.: US 2007/0067213 A1
(43) Pub. Date: Mar. 22, 2007

(54) System and method for modifying a baseline to predict sales of products

(75) Inventor: Robert G. Brown, Tarrytown, NY (US)

Correspondence Address: DICKSTEIN SHAPIRO LLP, 1177 AVENUE OF THE AMERICAS (6TH AVENUE), NEW YORK, NY, 10036-2714, US

(73) Assignee: Spar Group, Inc., Tarrytown, NY (US)

(21) Appl. No.: 11/598,942

(22) Filed: Nov. 13, 2006

Related U.S. Application Data
(63) Continuation of application No. 09/950,526, filed on Sep. 10, 2001, now abandoned.
(60) Provisional application No. 60/280,575, filed on Mar. 30, 2001.

(51) Int. Cl. G06F 17/30

(52) U.S. Cl. 705/10

(57) ABSTRACT

Modifying factors are calculated using pre-factors that are identified as influencing a baseline calculation. The modifying factors are applied to the baseline calculation to more accurately forecast the effect of real market forces as identified by the pre-factors on a baseline.

### CROSS REFERENCE

This application is based on and claims priority to U.S. Patent Provisional Application No. 60/280,575, filed Mar. 30, 2001, and patent application Ser. No. 09/950,526 filed Sep. 10, 2001, both entitled A SYSTEM AND METHOD FOR MODIFYING A BASELAIN TO PREDICT SALES OF PRODUCTS, the entire disclosures of which is hereby incorporated by reference.

### FIELD OF THE INVENTION

This invention relates to a system and method for electronically modifying baselines. More particularly, the invention is directed to modifying historic sales baselines by evaluating product and consumer characteristics in order to accurately predict the impact of promotions on sales to specific groups of consumers.

### BACKGROUND OF THE INVENTION

In the product and service industries, a major challenge facing businesses is to evaluate the financial success of specific business strategies and practices. To assist them, businesses rely on mathematical models that represent general and/or specific business patterns. For example, the number of blue shirts sold in the month of May over the past five years can be used to predict the number of blue shirts that will sell in the following month of May. These models, known as “baselines,” are heavily relied upon by businesses for strategic planning. Software packages for creating baselines, for example SPARLINE, are available and well known in the art.

Businesses are estimated to spend billions of dollars annually on promotional activity and advertising. Continuing with the above example, a manufacturer runs a special promotion that lowers the price of blue shirts by 50%. After the promotion, the manufacturer compares sales data for the period surrounding the promotion with the historical baseline sales data. The comparison is used to analyze the effectiveness of the special promotional activity.

Unfortunately, conclusions drawn from merely evaluating the differences between promotional sales data and baseline sales data are misleading and potentially disastrous for business strategists. For example, a pet food manufacturer offers its pet food at a reduced price during a promotional period of time. After the promotion, the number of sales made during the promotion are compared with the historical baseline of pet food sales. The pet food manufacturer receives sales data indicating that consumers purchased 10,000 cans of pet food during the promotional period that, according to the baseline and absent the promotion, would not have otherwise been sold. Therefore, the business is likely to conclude that the promotional activity yielded profits from the sales of the 10,000 cans of pet food, and that the promotion was a financial success.

Many factors contribute to sales, however, and such factors are often overlooked during the creation of a baseline. In the above pet food example, many of the 10,000 cans of pet food would have been purchased by the same consumers over the course of the year at non-promotional prices. Known in the art as “pantry loading,” consumers take advantage of promotions and essentially stockpile their “pantries” with a large quantity of a given product for eventual, future consumption. Consumers who engage in pantry loading avoid paying the higher, non-promotional price in the future with the overall result that manufacturers actually lose money because of the promotion. Because factors such as pantry loading frequently are ignored during creation of baselines, baselines are inherently inaccurate when used to analyze special promotional activities. Businesses that rely on inaccurate baselines may excessively lower prices, misidentify or ignore specific consumer groups, overlook product/service characteristics and eventually misidentify losses as profits.

### SUMMARY OF THE INVENTION

There is a need for a system and method to modify a baseline in order to accurately predict the impact on sales from advertising, marketing, promotions and the like.

The present invention provides a method of adjusting a baseline by enabling a user to identify and assign values to a plurality of factors that would have caused the baseline to be different had the factors been included to generate the baseline. These factors include information about different types of consumer groups, for example consumers who are persuaded by price, brand and size, loyalty to specific brands and store chains, and product use. Moreover, baseline modifying factors can also include promotion information, for example price, product size/weight dimensions and product shelf life. A plurality of general modifying factors, for example population trends, short and long-term economic forecasts and the like also affect baselines and are also rated in order to contribute to a modified baseline. All of these baseline modifying factors are assessed and assigned values to contribute to modifying an existing baseline.

The present invention generates modified baselines, and further performs calculations that represent specific distributions of consumer groups, consumer behavior, and sales for a specific promotion or event. For example, the numbers of consumers who purchase a product because of a brand name, product size, price, and shelf life are preferably identified for each product item sold. Distributors, retailers and other entities involved in the distribution chain are thereafter better equipped to make informed decisions and better predictions regarding special promotional activity.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example of a hardware arrangement for network based method of modifying a baseline according to the principles of the present invention;

FIG. 2 is a block diagram of the functional elements constructed in accordance with the present invention;

FIG. 3 shows a flowchart illustrating the steps for modifying a baseline according to an embodiment of the present invention;

FIG. 4 illustrates another flowchart for the steps for modifying a baseline according to an embodiment of the present invention;

FIG. 5 depicts a main menu options screen according to an embodiment of the present invention;

FIG. 6 illustrates an input screen for selecting an product according to an embodiment of the present invention;

FIG. 7 illustrates an input screen for entering product profile information according to an embodiment of the present invention;

FIG. 8 is an input screen for entering promotion information according to an embodiment of the present invention;

FIG. 9 illustrates output options for displaying modified baseline data;

FIG. 10 shows a bar graph of modified baseline data;

FIG. 11 shows modified baseline information directed to individual chain sales to customers according to an embodiment of the present invention;

FIG. 12 illustrates modified baseline information directed to size switchers according to an embodiment of the present invention;

FIG. 13 depicts modified baseline information directed to brand switchers of the same manufacturer according to an embodiment of the present invention;

FIG. 14 shows modified baseline information directed to brand switchers of competitive manufacturers according to an embodiment of the present invention;

FIG. 15 illustrates modified baseline information directed to price buyers according to an embodiment of the present invention;

FIG. 16 shows modified baseline information directed to occasional users according to an embodiment of the present invention; and

FIG. 17 shows modified baseline information directed to chain analysis according to an embodiment of the present invention.

### DETAILED DESCRIPTION OF EMBODIMENTS OF THE INVENTION

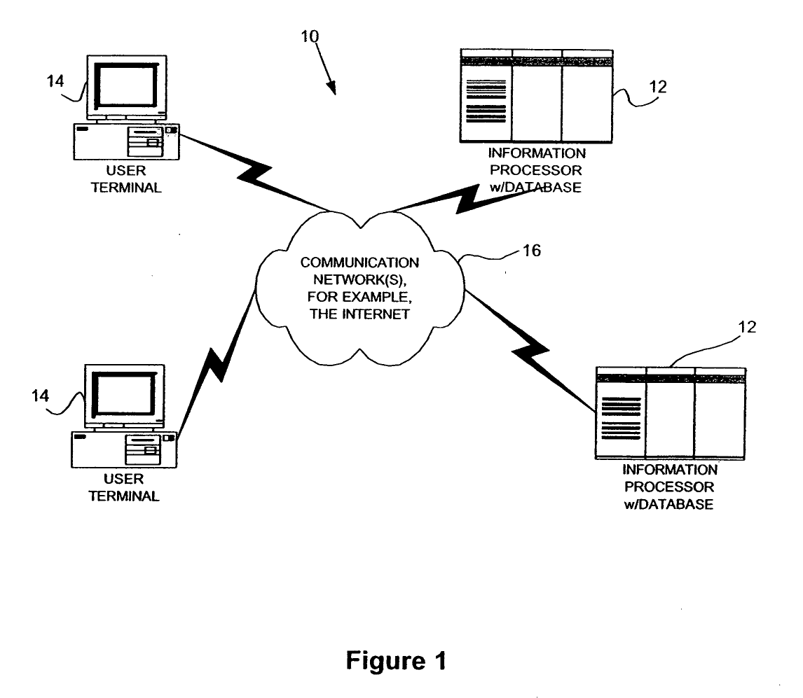

Referring to the drawing figures in which like reference designators refer to like elements, there is shown in FIG. 1 an example of a first preferred embodiment including a hardware arrangement for a network based method of modifying a baseline and designated generally as “10”. Baseline modifying system 10 is comprised of at least one information processor 12 and at least one user terminal 14, each of which are coupled to communication network 16. Information processor 12 preferably includes all databases necessary to support the present invention. However, it is contemplated that information processor 12 can access any required databases via communication network 16 or any other communication network to which information processor 12 may be coupled. Communication network 16 is preferably a global public communication network such as the Internet, but can also be a wide area network (WAN), local area network (LAN), or other network that enables two or more computers to communicate with each other.

In an alternate, second preferred embodiment, baseline modifying system 10 is operated within a single user workstation in which all of the functionality described herein is provided. In a single workstation environment, users do not transmit data to and from separate devices. Instead, a fully functional application is installed on a single workstation thereby improving processing time while reducing security threats and technical support services.

In the first preferred embodiment, information processor 12 and user terminal 14 are any devices that are capable of sending and receiving data across communication network 16, e.g., mainframe computers, mini computers, personal computers, laptop computers, personal digital assistants (PDA) and Internet access devices such as Web TV. In addition, user terminals 14 are preferably equipped with a web browser, such as MICROSOFT INTERNET EXPLORER, NETSCAPE NAVIGATOR and the like. Information processors 12 and terminals 14 are coupled to communication network 16 using any known data communication networking technology.

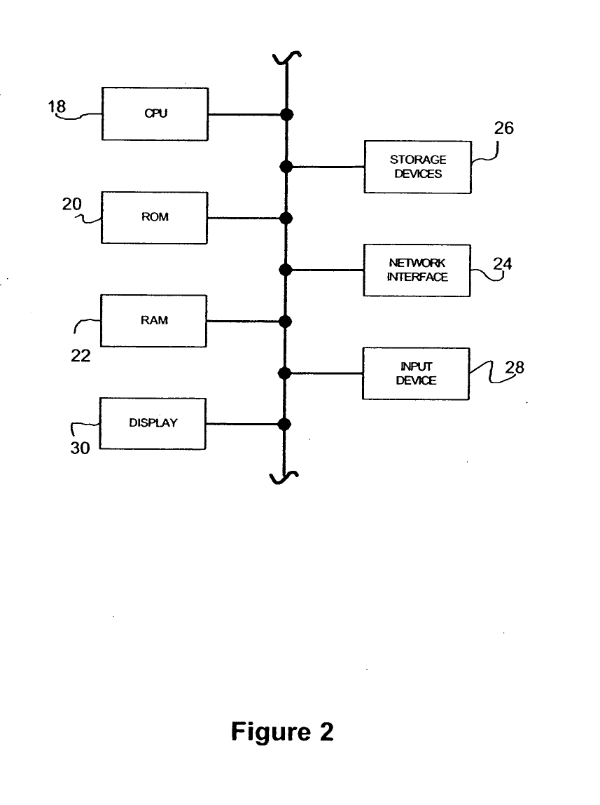

As shown in FIGS. 1 and 2, the functional elements of each information processor 12 include one or more central processing units (CPU) 18 used to execute software code and control the operation of information processor 12, read-only memory (ROM) 20, random access memory (RAM) 22, one or more network interfaces 24 to transmit and receive data to and from other computing devices across a communication network, storage devices 26 such as a hard disk drive, floppy disk drive, tape drive, CD ROM or DVD or storing program code, databases and application data, one or more input devices 28 such as a keyboard, mouse, track ball, microphone and the like, and a display 30.

The various components of information processor 12 need not be physically contained within the same chassis or even located in a single location. For example, storage device 26 may be located at a site which is remote from the remaining elements of information processors 12, and may even be connected to CPU 18 across communication network 16 via network interface 24. Information processors 12 include a memory equipped with sufficient storage to provide the necessary databases, forums, and other community services as well as acting as a web server for communicating hypertext markup language (HTML), Java applets, Active-X control programs and the like to user terminals 14. Information processors 12 are arranged with components, for example those shown in FIG. 2, suitable for the expected operating environment of information processor 12. The CPU(s) 18, network interface(s) 24 and memory and storage devices are selected to ensure that capacities are arranged to accommodate expected demand.

As used herein, the term “link” refers to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements shown in FIG. 2 (designated by reference numerals 18-30) are the same categories of functional elements present in user terminals 14. However, not all elements need be present, for example storage devices in the case of PDA's and the capacities of the various elements are arranged to accommodate the expected user demand. For example, CPU 18 in user terminal 14 may be a smaller capacity CPU than the CPU present in the information processor 12. Similarly, it is likely that the information processor 12 will include storage devices of a much higher capacity than storage devices present in user terminal 14.

Of course, one of ordinary skill in the art will understand that the capabilities of the functional elements can be adjusted as needed. The nature of the invention is such that one skilled in the art of writing computer executable code (software) can implement the described functions using one or more of a combination of popular computer programming languages and developing environments including, but not limited to C++, Visual Basic, Java, HTML and web application development applications.

Although the present invention is described by way of example herein and in terms of a web-based system using web browsers and a website server (information processor 12), baseline modifying system 10 is not limited to the above configuration. It is contemplated that baseline modifying system 10 can be arranged such that user terminals 14 can communicate with and display data received from information processors 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on user terminal 14, for example, Windows 3.x, Windows 95, Windows 98, WINDOWS NT, WINDOWS 2000, WINDOWS ME, WINDOWS CE, MAC OS, UNIX, LINUX, PALM OS and any suitable operating system.

As used herein, references to displaying data on user terminal 14 refers to the process of communicating data to the terminal across communication network 16 and processing the data such that the data is viewed on the terminal displays 30, for example by using a web browser and the like. As is common with web browsing software, the display screen on terminals 14 present sites within the networked system 10 such that a user can proceed from site to site within the system by selecting a desired link.

Also as used herein, the term “merchandiser” refers to a person or group of people who produce and/or distribute products to be sold in retail stores. Moreover, the term “store chain” refers to a retail store company name. The store chain typically comprises more than one physical store location.

Further, references to displaying data on user terminal 14 regard to the process of communicating data to the terminal across communication network 16 and processing the data such that the data can be viewed on the user terminals' displays 30 using web browsers and the like. The display screens on user terminals 14 present areas within baseline modifying system 10 such that a user can proceed from area to area within the baseline modifying system 10 by selecting a desired link. Therefore, each user's experience with baseline modifying system 10 is based on the order with which they progress through the display screens. Graphic controls are made frequently available in the display screens and modules to provide convenient navigation between the display screens and modules of baseline modifying system 10. In other words, because the system is not completely hierarchical in its arrangement of display screens, users can proceed from area to area without the need to “backtrack” through a series of display screens. For that reason, and unless stated otherwise, the following discussion is not intended to represent any sequential operation steps, but rather to illustrate the components of baseline modifying system 10.

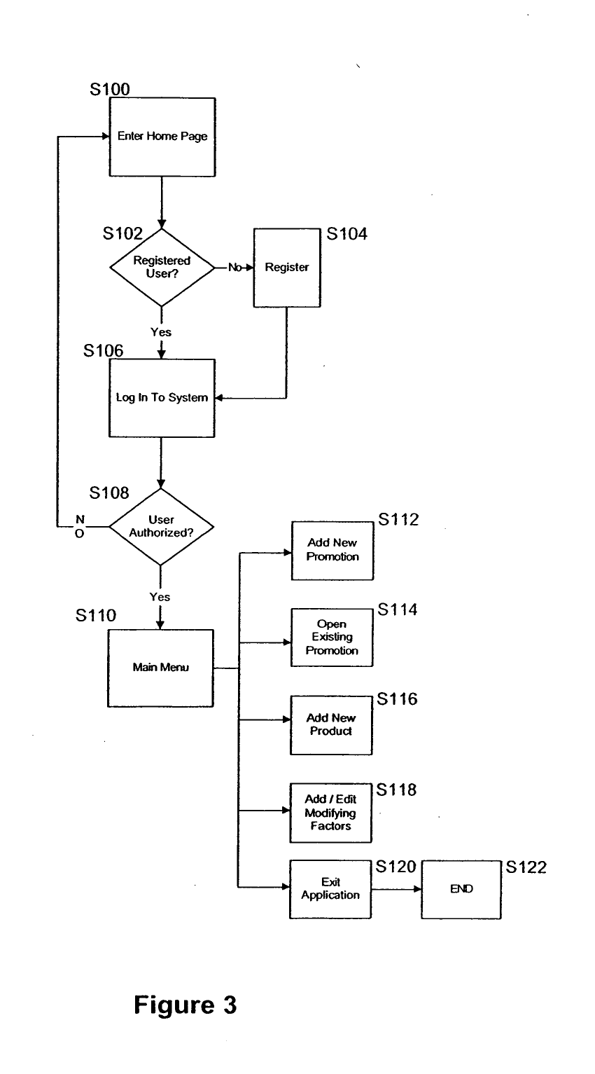

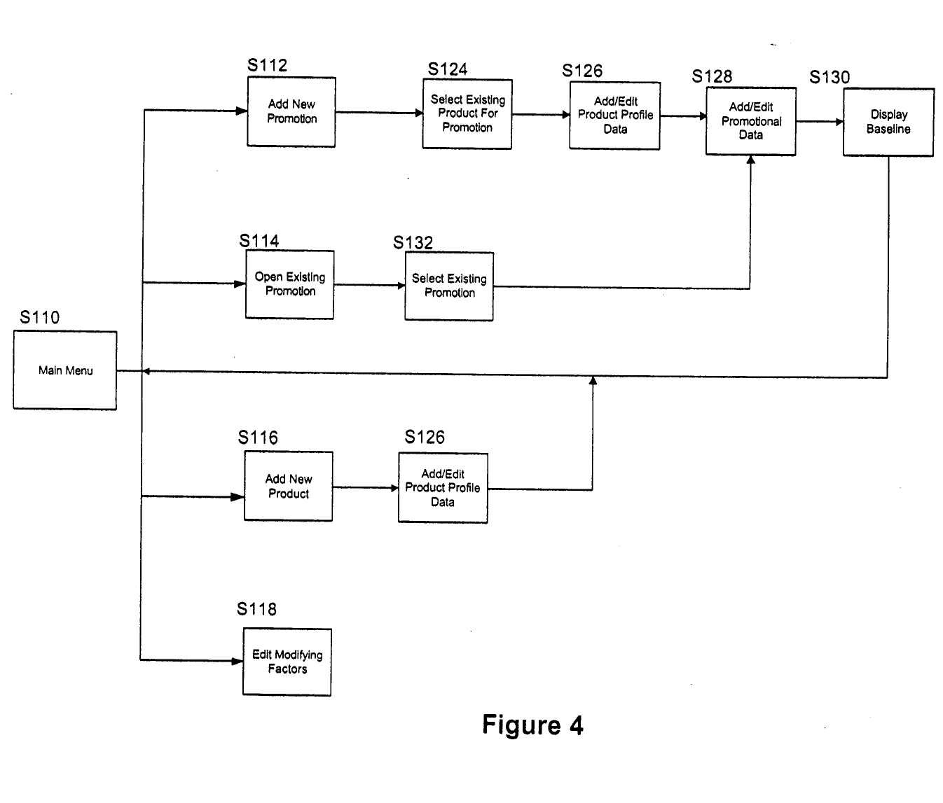

The above described hardware provides a system which advantageously allows users to modify promotional baselines. The specific functionality provided by baseline modifying system 10, and in particular information processor 12, is illustrated in the following example of the baseline modifying process including the interaction between the modules with reference to flow charts as shown in FIG. 3 and FIG. 4.

FIG. 3 demonstrates a flowchart illustrating the steps for modifying a baseline. In a preferred embodiment, an operator of user terminal 14 accesses the baseline modifying system 10 by visiting a home page web site maintained by the information processor 12 (step S100). In order to gain access to restricted areas of baseline modifying system 10, the user must register and obtain an authorized user identification (“ID”) and password (step S102). If the user has not previously registered, then he or she is preferably presented with a registration display screen to obtain a registration name (e.g., the participant's social security number) and a password (preferably randomly generated by the system) (step S104). Thereafter, the user is authorized to access restricted areas of baseline modifying system 10 by providing his or her user ID and password. Of course, one skilled in the art will recognize that user ID's and passwords can change over time, and further that authorization can be granted and removed over time.

Continuing with the flowchart shown in FIG. 3, once the user registers or has previously registered, for example, by submitting an electronic registration data entry form, he or she thereafter provides a ID and password to request access to restricted areas of baseline modifying system 10 (step S106). Once a user submits his or her user ID and password, the information processor 12 makes a determination whether to authorize the user by granting access to baseline modifying system 10 (step S108). If the information processor 12 concludes that the person completing the form is not authorized to participate in the baseline modifying system 10, entry is denied and the user terminal 14 is presented with the “home” page as described in step S100. Alternatively, entry into restricted areas of baseline modifying system 10 is granted.

Once the user has successfully “logged in” to baseline modifying system 10, user terminal 14 is preferably presented with a display screen that provides a “Main Menu” from which many of the preferred functions of baseline modification system 10 are provided (step S110). Included in the available list of functions for the user is the ability to Add a New Promotion (step S112), Open an Existing Promotion (step S114), Add a New Product (step S116), Add/Edit Modifying Factors (step S118) and Exit Application (step S120). The option to exit the application (step S120) is preferably frequently available in many of the display screens and modules described below. If Exit Application (step S120) is selected, the user preferably logs out of baseline modifying system and terminates the session (step S122). This list of choices is not exhaustive, of course, one skilled in the art will recognize that additional Main Menu functions, for example service related promotions, electronic file management and report output can be added.

FIG. 4 illustrates a flowchart showing in greater detail the choices available to a user who has successfully logged in to baseline modifying system 10 and is specifically directed to steps S112-S116.

Step S112 enables a user to add a new promotion into baseline modifying system 10. After selecting Add a New Promotion (step S112), the user selects a product to be identified for the promotion that is currently being entered (step S124). The user preferably selects a product for the promotion, and thereafter adds and/or edits product profile data for the selected product (step S126). Examples of product profile data include the likelihood of increased consumption for a product, the likelihood that pantry loading will occur as a result of the promotion, and the percentage of consumers who are likely switch from a different size, brand or price. The user is preferably prompted to add or edit data for the promotion that is being entered after completing data entry for the product profile (step S128). For example, the user enters a promotion name with detailed information regarding the promotion (e.g., the dates the promotion will run, incremental consumption, forward buying, and base consumer franchise).

After the user has completed entering promotional information, he is preferably prompted to generate a modified baseline (step S130). Information processor 12 preferably applies the data submitted by the user to modify a baseline, and further to estimate numbers of specific consumers who purchased the product and associated reasons. Once the modified baseline is generated, information processor 12 preferably displays the modified baseline for the user's review. After the user has reviewed the modified baseline, he is preferably prompted to make data entry changes to any of the data elements previously entered. As noted above, graphic controls enabling users to navigate within baseline modifying system 10 are frequently provided.

Moreover, a user can elect to edit data for an existing promotion rather than entering a new promotion. In step S114 (FIG. 3), the user selects Open an Existing Promotion from the main menu of baseline modifying system 10. Thereafter, the user is prompted to select an existing promotion, for example, by selecting a choice from a drop down list (step S132). The user is preferably prompted to add or edit promotion data as described above with regard to step S128. After the user inputs the promotion data, the user can cause the system to generate and display a modified baseline in response to the data entered in the promotion data section (step S130). After the user has received the modified displayed baseline, he is preferably prompted to return to the main menu of baseline modifying system 10 (step S110).

In addition to adding or editing a promotion, a user is afforded an opportunity to add a new product from the main menu of baseline modifying system 10. After selecting the option for adding a new product (step S116), a user is preferably prompted to enter a name and associated details regarding the product. Thereafter, the user enters product profile information. The corresponding steps to enter product profile information are described above (step S126). After the user enters the product profile information, he is preferably prompted to return to the main menu as described above (step S110).

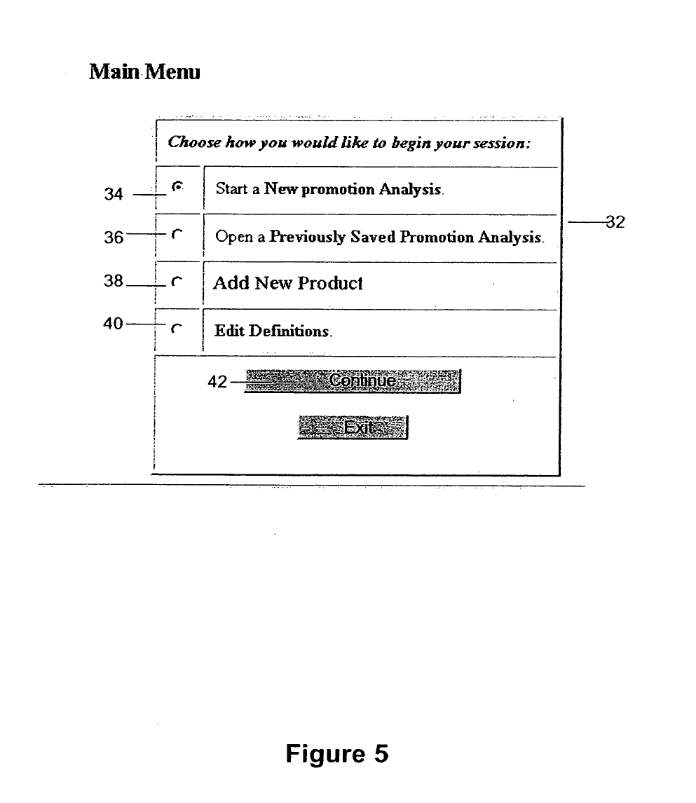

FIGS. 5-17 illustrate a preferred embodiment of an implementation of the invention and are now discussed.

FIG. 5 shows an example display screen presenting main menu 32 of baseline modifying system 10. This example shows one embodiment of the present invention and is preferably comprised of one or more graphic controls including, but not limited to, title bars, labels, text input areas, radio and push buttons. Of course, other design layouts can be fashioned using other types of graphic display controls known to those skilled in the art.

When selecting the graphic controls in baseline modifying main menu 32, content corresponding to the selections is caused to be displayed in another display screen. Main menu 32 is preferably presented in the case where the user has successfully logged into baseline modifying system 10.

As shown in FIG. 5, main menu 32 preferably includes various options for operating baseline modifying system 10. For example and as described above, the user selects Start a New Promotion Analysis 34 to enter data for a new product promotion, Open a Previously Saved Promotion 36 to review and/or modify a previous entry, Add a New Product 38 to enter a new product item, and Add/Edit Modifying Factors 40 to adjust modifying factors. After the user has made a selection, he or he continues the process preferably by clicking on Continue Button 42.

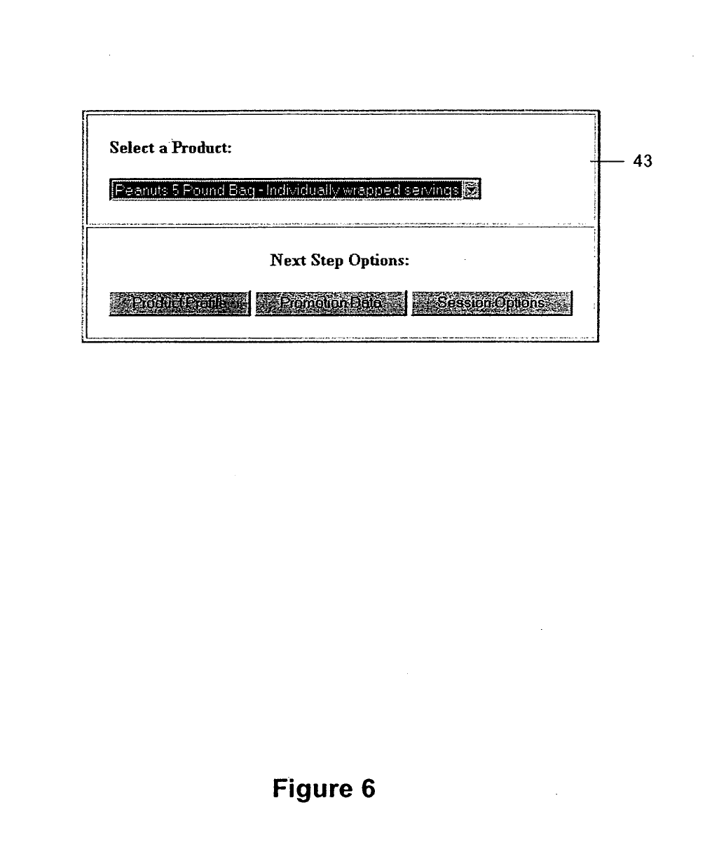

Access to the various functions provided by Start a New Promotion Analysis 34 (FIG. 5) is explained in greater detail with reference to FIGS. 6-17. When a user desires to perform an analysis for a new promotion, he or she preferably selects Start a New Promotion Analysis 34 from the main menu 32 and the user then selects a product for analysis, for example by making a selection from a drop-down list. FIG. 6 shows an example product selection screen 43 that is preferably displayed after selecting Start a New Promotional Analysis 34. Although the preferred embodiment is described in terms of the sale of retail goods, a person skilled in the art will recognize that the present invention can be used in any application that benefits from baseline analysis, such as the wholesale distribution of goods or the distribution of services.

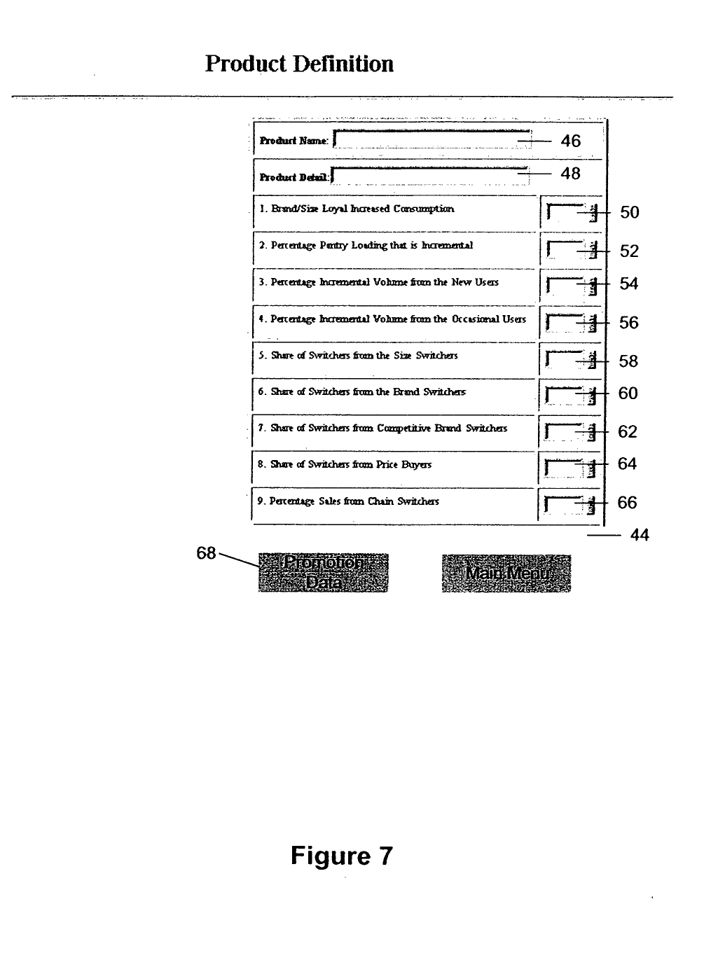

A product profile is created whenever a new product is entered in baseline modifying system 10. As noted above, the present system works on existing baselines, and a baseline for the new product is available for modification. When a user enters a new promotion, he is prompted to edit values in the product profile display screen, substantially as shown in FIG. 7, that were submitted when the product was initially entered. Therein, two text boxes, Product Name 46 and Product Detail 48, are available for a user to enter a unique name for the product and associated details. Additionally, a plurality of modifying factors 50-66 regarding consumer groups, consumer behavior and product descriptions are identified and quantified.

Product profile display screen 44 includes a plurality of numerical data entry fields for entering variables (factors 50-66) that are used by the present invention to modify existing baselines.

In a preferred embodiment, each of the factors 50-66 are preferably entered as a percentage. In general, the modifying factors can be thought of as describing the nature of the relationship between the product and consumers. When a product is brand new, the user will at first estimate what the values should be used for the various factors. As the user gains more experience with the product over time, the user is able to refine the values used for the various factors 50-66.

In another preferred embodiment, each of the factors 50-66 are automatically provided and entered by baseline modifying system 10. For example, a user of baseline modifying system 10 enters a new product, e.g., peanuts, and the values in the product profile display screen (discussed below) are automatically entered by the system 10. The operator of baseline modifying system 10 preferably elects to manually add product profile data or have default values automatically provided.

A first factor, Brand/Size Loyal Increased Consumption 50 represents the relative weight of increased consumption for the given product expected as a result of a promotion. For example, if the product in question is candy, the increased consumption expected as the result of a promotion would be quite high because people consume different amounts of candy depending upon availability. If the product in question is toothpaste, the consumption percentage would be quite low because people consume substantially the same amounts of toothpaste each day. The factor Percentage Pantry Loading That Is Incremental 52 represents the amount of increased pantry loading that will occur as a result of a promotion. Consumers essentially stockpile their “pantries” with a large quantity of a given product for eventual, future consumption and avoid paying the higher, non-promotional price in the future. Both Brand/Size Loyal Increased Consumption 50 and Percentage Pantry Loading That Is Incremental 52 are factors that modify baselines and represent consumer group behavior with respect to a particular product.

Incremental Volume from New Users 54 and Incremental Volume from Occasional Users 56 represents the relative weight of increased consumption due to a promotion by either consumers who have never before purchased the product in question, or have occasionally purchased the product but are not “loyal” consumers of the product. As noted above, incremental volume from new users and occasional users represent purchases that, but for the promotion, would not have been made. Other types of consumer groups identified by data entry fields in Product Profile display screen 44 include Size Switchers 58 and Brand Switchers 60. Size switchers represent consumers who typically purchase a different size of the same brand and product but will switch to the promotional item. Brand switchers represent consumers who typically purchase the same brand, for example a brand of soda, but will switching to another product within the brand, for example diet soda.

Additionally, Competitive Brand Switchers 62, Price Buyers 64, and Chain Switchers 66 are preferably assessed and assigned percentage values. Competitive Brand Switchers 62 represent consumers who switch from one name brand to another. Price Buyers 64 represent consumers who are motivated to purchase because of price. Chain Switchers 66 represent consumers who are motivated to leave the store chain they typically frequent to purchase the product.

Other modifying factors are envisioned that can be entered by the user. For example, product-related modifying factors including product size and weight dimensions, product use, product shelf life and the like. Additionally, general modifying factors can be entered, for example population trends, economic forecasts, and the like. The modifying factors shown in FIG. 7 are representative of the kind of modifying factors used by the present invention to modify a baseline.

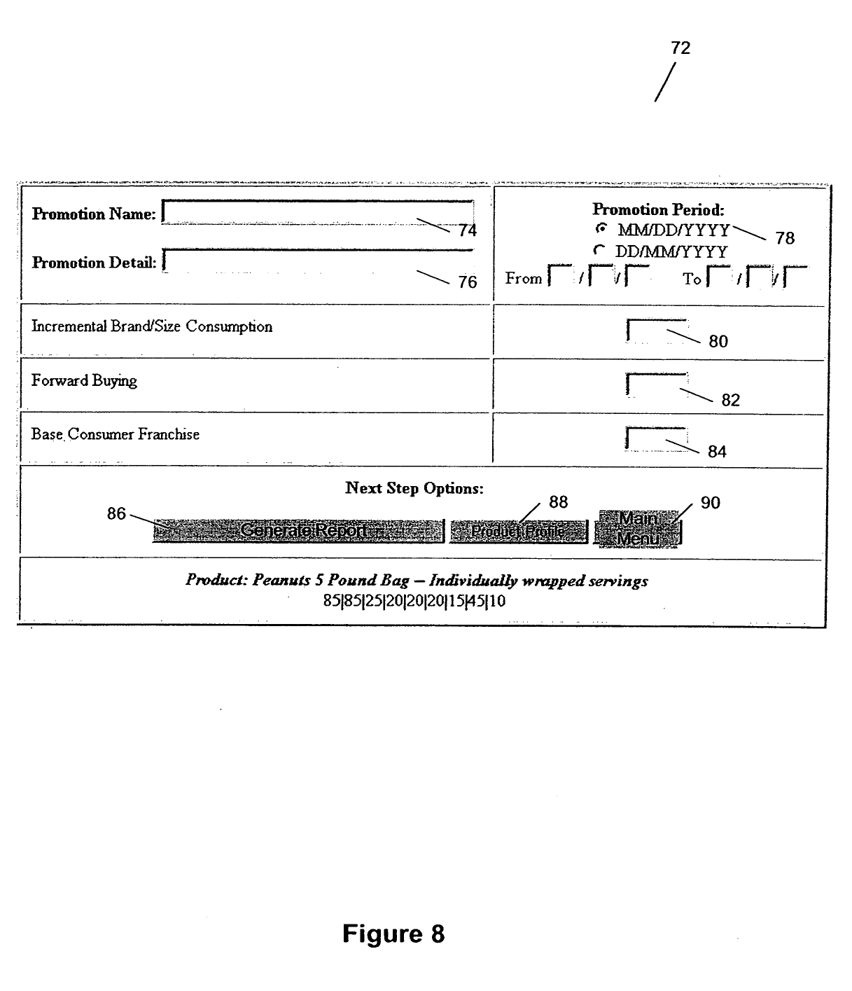

In addition to the types of modifying factors described above with reference to FIG. 7 and the promotion data values described above with reference to FIG. 8, baseline modifying system 10 preferably includes a plurality of weighted factors which are applied to any of the above-described data. For example, a user decides that a particular promotion impacts sales to the number of competitive brand switchers. The weighted value, for example a percentage value, is multiplied by the value entered by the user in the data field for Share of Switchers from Competitive Brand Switchers 62 (FIG. 7). These weighted values are preferably applied to any data values in baseline modifying system 10.

Each modifying factor may be entered using the data entry boxes in the product profile page. Furthermore, a help screen explaining each modifying factor may be included therewith.

After the user enters the product profile information, he preferably clicks Promotion Data button 68 to continue in the promotion addition process. Alternatively, the user can select Return to Main Menu button 70

FIG. 8 shows an example Promotion Data display screen 72. In the embodiment shown, the user enters text data in Promotion Name 74 and Promotion Detail 76 text boxes to help the user keep track of and differentiate between promotions. Promotion dates are preferably entered in Promotion Period 78. In addition to descriptive text and dates for a specific promotion, a user of baseline modifying system 10 preferably enters values for Incremental Brand/Size Consumption 80, Forward Buying 82 and Base Consumer Franchise 84. Incremental Brand/Size Consumption 80 represents the number of items sold during the promotional period that would not have otherwise been sold. Forward Buying 82 represents the number of items purchased by retailers that are stockpiled in order to avoid paying a higher manufacturer price. By stockpiling the item, the retailer does not have to purchase the item from the manufacturer in the future at the regular, higher price. Base Consumer Franchise 84 represents the number of items that would have sold regardless of the promotional event. Base Consumer Franchise 84 data are provided, for example, by evaluating prior sales data and baselines.

When the user has completed data entry in Promotion Data display screen 72, he preferably proceeds to view the modified baseline by clicking Generate Report button 86. The user is also afforded an opportunity to edit data regarding the selected product by clicking on Product Profile button 88 that will return the user to the Product Profile input screen 44 illustrated in FIG. 7. Alternatively, the user may return to Main Menu 32 by clicking Main Menu button 90.

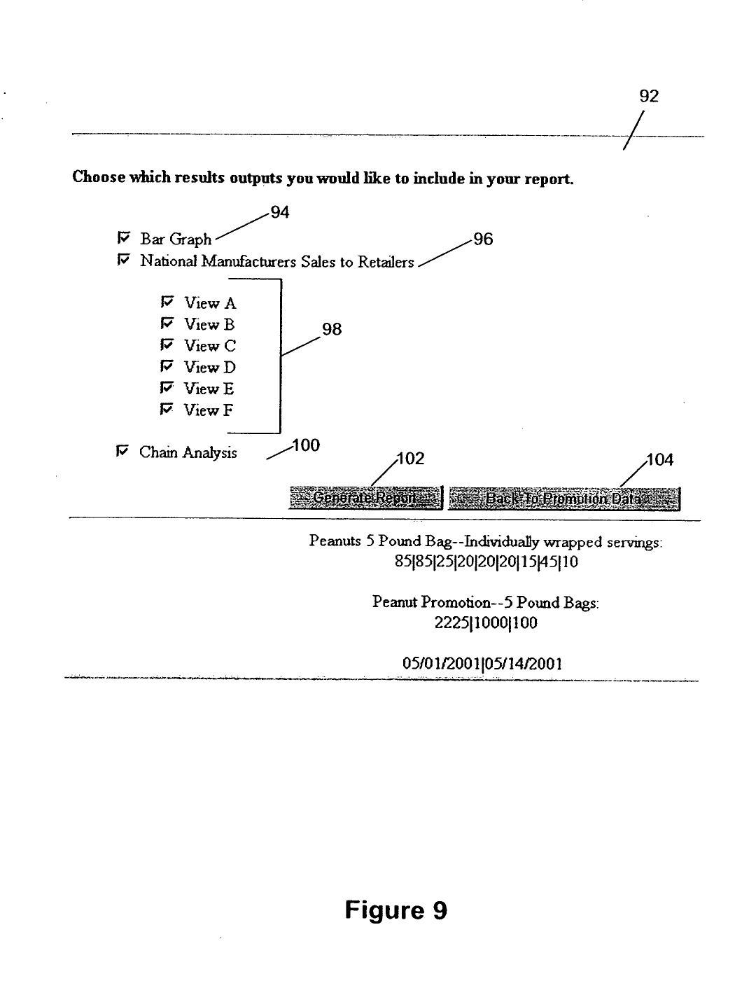

Now referring to FIG. 9, the user selects output options in Report Output Options screen 92 by clicking checkbox controls which correspond with specific reports. For example, the user can select Bar Graph checkbox 94 to view a summary bar graph report, National Manufacturers Sales checkbox 96 to view details on individual store chain sales, Consumer Group checkboxes 98 to view detailed reports regarding sales to specific consumer groups, and Chain Analysis checkbox 100 to view details regarding the volume of items sold and a distribution of specific consumer groups to whom the products were sold.

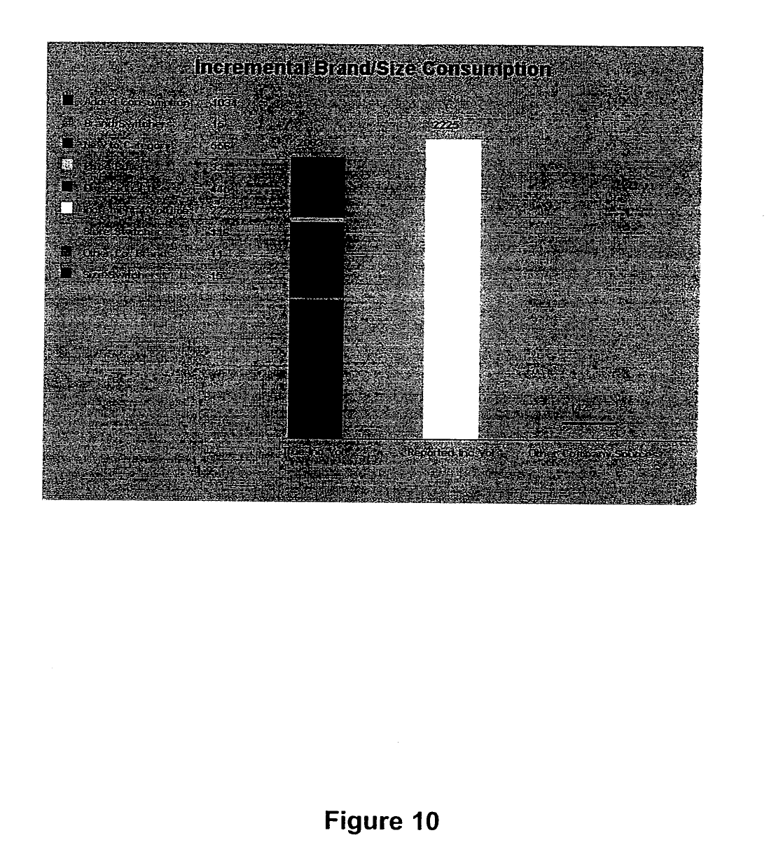

After the user makes his or her selections in Report Output Options Screen 92, the user clicks on Generate Report button 102 to produce the report output. Alternatively, the user returns to Enter Promotion Data display screen 72 by clicking Back to Promotion Data button 104. When the user clicks on Generate Report button 102, report output is generated which correlates with the checkboxes the user previously selected in the Report Output Options screen 92. For example, if the user selects Bar Graph checkbox 94 in the Report Output Options screen 92 only, the user is presented with only a bar graph report, substantially as shown in FIG. 10.

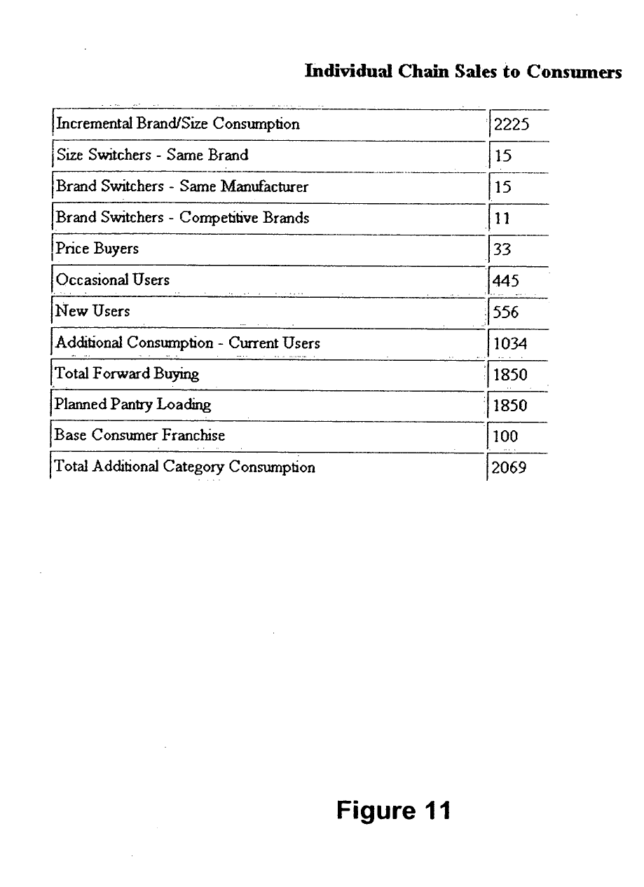

FIG. 11 shows an example report identifying individual chain sales to consumers. The report shown in FIG. 11 reflects the modified baseline by factoring in the values submitted by the user in the product definition screen (FIG. 7) and the promotion data screen (FIG. 8).

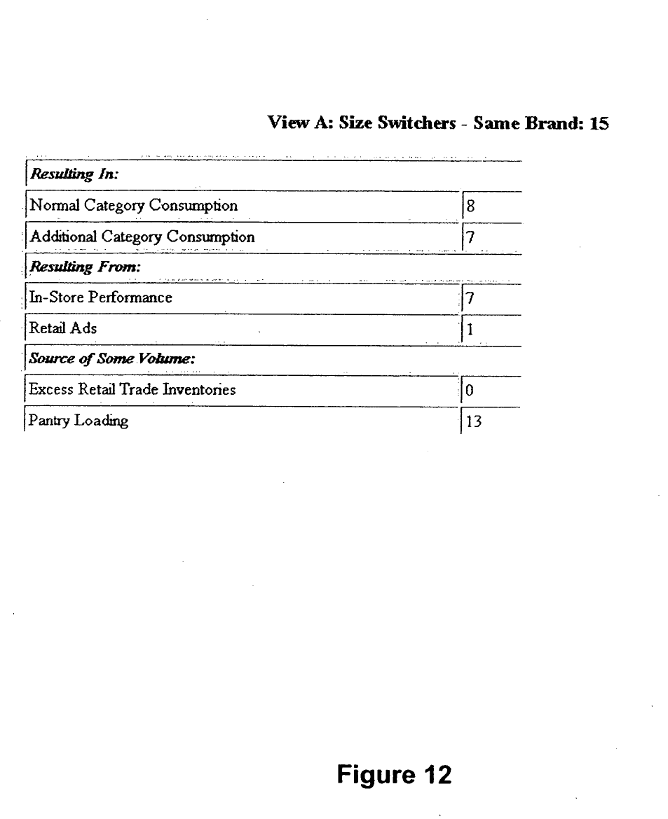

FIG. 12 through FIG. 16 further detail the number of size switchers, brand switchers, competitive brand switchers, price buyers, and occasional users as identified in the bar graph in FIG. 10. FIG. 12 breaks out the number of size switchers, in this example 15, resulting in normal category consumption and additional category consumption. Normal category consumption represents the number of items that would have been sold had the promotion not been run. In the example shown in FIG. 12, there are 15 items sold that were sold to size switchers and of those, 8 sales resulted from in normal category consumption. Of the 8 sales resulting from normal category consumption, 7 items were sold from in-store performance, and 1 item sold from retail advertisement. Moreover, the report identifies the source of some of the volume resulting from excess retail trade inventors, in this example 0, and pantry loading, in this example 13.

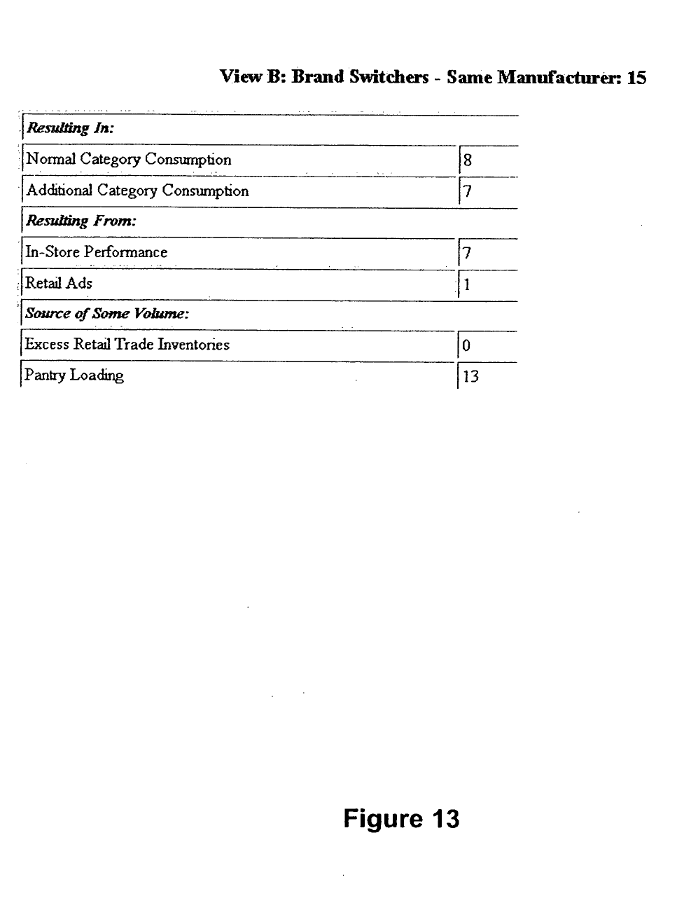

The report shown in FIG. 13 represents the number of items sold to brand switchers from the same manufacturer. Similar to the values shown in FIG. 12, the number of items sold to brand switchers is broken down by normal category consumption and additional category consumption. Moreover, the items sold as a result of normal category consumption are further identified as resulting from in-store performance and retail advertisement. The source of some volume is identified as resulting from excess retail trade inventories and pantry loading.

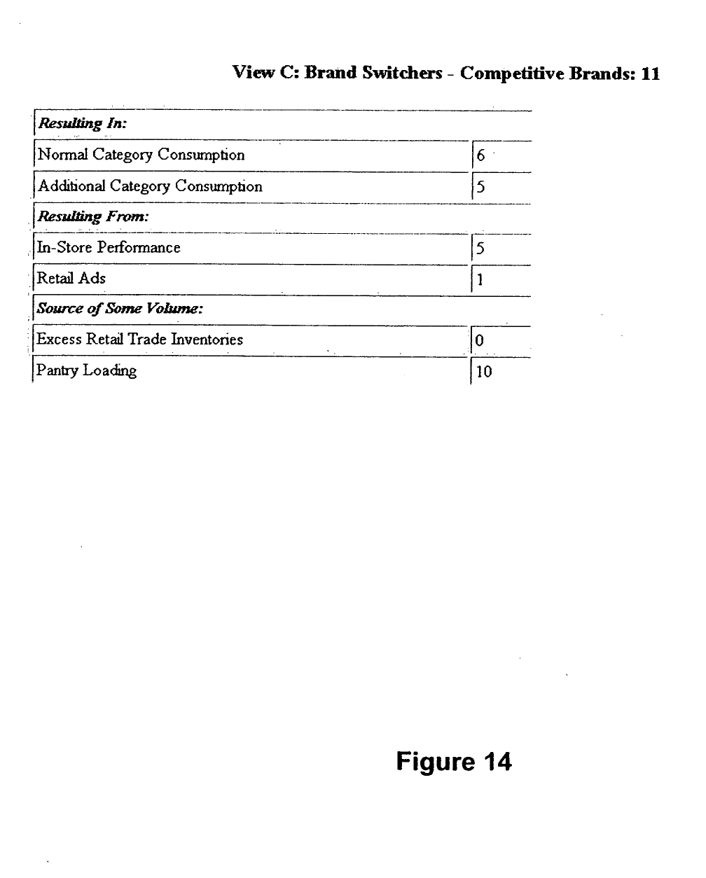

The report shown in FIG. 14 identifies the number of items sold to brand switchers who have switched from competitive manufacturers, and identifies the number of items sold as a result of normal category consumption and additional category consumption. Similar to the report shown in FIGS. 12 and 13, the number of items sold as a result of normal category consumption are further identified as resulting from in store performance and retail adds, and the source of some volume is identified as resulting from excess retail trade inventories and pantry loading.

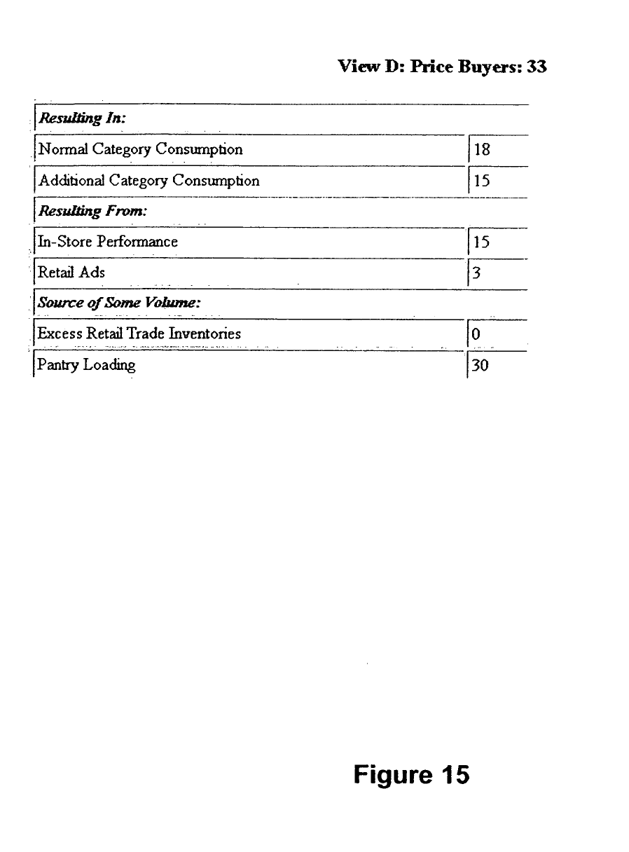

The report shown in FIG. 15 identifies buyers who purchased the promotional item because of the price. As identified in the previous reports (FIGS. 12-14) the number of items sold to price buyers are identified as normal category consumption and additional category consumption, with the normal category consumption being further identified as resulting from in- store performance and retail adds. As shown in the previous reports (FIGS. 12-14) the volume of sales is identified as resulting from excess retail inventories and pantry loading.

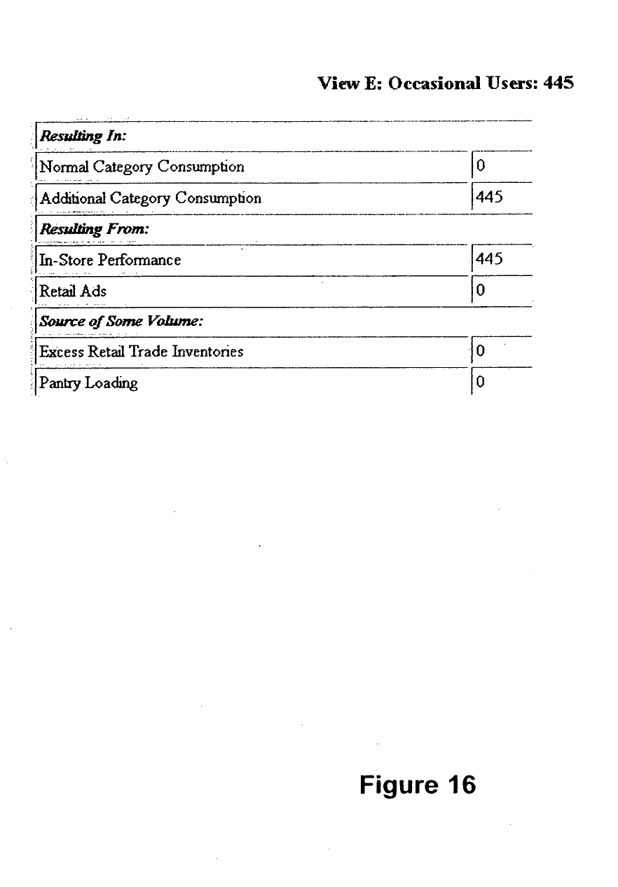

The report shown in FIG. 16 represents the number of items purchased by occasional users, and has the same categories of information as described above with reference to FIGS. 12-15. The number of items sold to occasional users is identified as additional category consumption because, as noted above, occasional users would not have purchased this item but for the running of the promotion. The items sold are a result of in-store performance, and the report further identifies some volume as resulting from excess retail trade inventories and pantry loading.

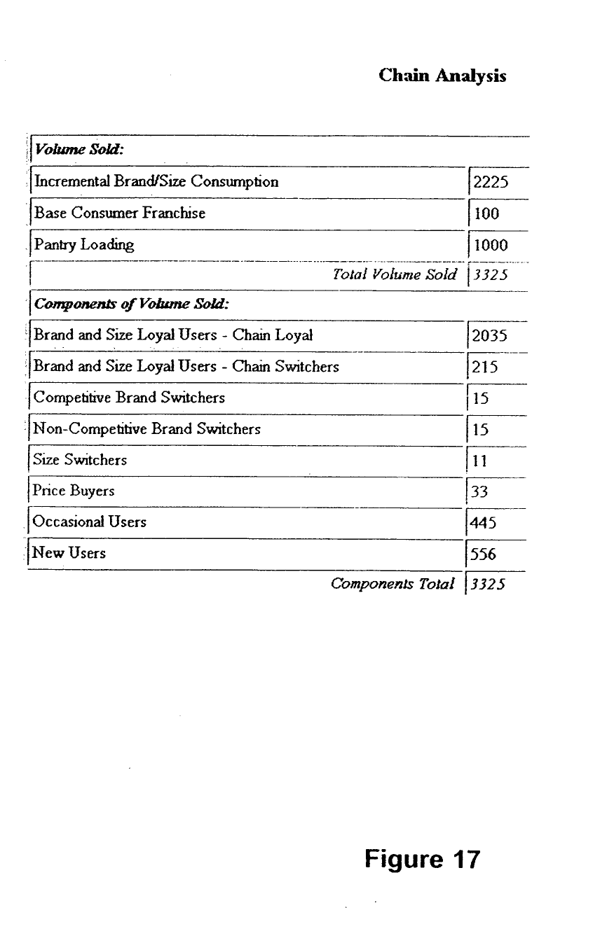

The report shown in FIG. 17 identifies chain analysis showing the items sold as a result of incremental brand/size consumption, base consumer franchise and pantry loading are aggregated and shown as a total volume sold. That total volume sold is further broken down by brand and size loyal users who are chain loyal users or chain switchers, competitive brand switchers, non-competitive brand switchers, size switchers, price buyers, occasional users and new users.

Access to the various functions provided by Open a Previously Saved Promotion Analysis 38 in Main Menu 32 is provided for the user who wishes to make modifications to a promotion that already exists in baseline modifying system 10.

When a user desires to review or edit a previously entered promotion, he preferably selects Open a Previously Saved Promotion Analysis 36 from Main Menu 32, and proceeds by clicking Continue button 42 (FIG. 5). Thereafter, he is presented with Select a Product screen 43 as shown in FIG. 6. Therein, the user selects a specific promotion using a control, for example a drop-down list that correlates with a previously saved promotion. Once the desired promotion is selected, the user clicks Product Profile button (FIG. 6) to edit previously saved product profile information (FIG. 7). Alternatively, the user clicks Promotion Data button (FIG. 6) to edit promotion data (FIG. 8), or clicks Main Menu button to be presented with Main Menu 32 (FIG. 5).

In a preferred embodiment, products that have been previously entered by users are available for adding promotion data therefor. As described above with reference to FIG. 5, a user can add new promotions or edit existing promotions based on previously entered products. To facilitate adding a new product, a user preferably selects Add a New Product 36 available in Main Menu 32 (FIG. 5).

Once the user selects Add a New Product 36 from within Main Menu 32, he is preferably presented with a product profile screen as shown in FIG. 7. As described above in reference to adding a new promotion, the product profile display screen 44 enables a user to enter a product name, associated details regarding the product and a plurality of percentages used by the present invention to modify existing baselines. After the user enters the values corresponding to the modifying factors 50-66, the user is preferably prompted to save the product and associated data.

Additional functionality provided by baseline modifying system 10 is now further described by way of an example.

A food manufacturer decides to run a promotion on peanuts. The peanuts are packaged in small, individual servings. The packages of peanuts are grouped for sale in a single large, five pound bag. The manufacturer decides to sell the five pound bag of peanuts for 50% of the usual, non-promotional price, and decides to run the promotion for two weeks during the month of May.

Using the present invention, a user who represents the manufacturer, logs into baseline modifying system 10 by supplying the requisite user identification and password. Thereafter, the user selects Add a New Product 38 from Main Menu 32 (FIG. 5).

The user provides a name and detail of the product and proceeds to enter product profile data. For Brand/Size Loyal Increased Consumption 50, the user enters a relatively high value of 85% because peanuts are the type of product that people consume when it is available to them. The user decides to enter a high value, 85%, for Percentage Pantry Loading That is Incremental 52 because peanuts are the type of item that consumers would typically purchase in larger quantity and store for extended periods. For Percentage Incremental Volume from New Users 54, the user enters a lower value of 25% because new buyers of a brand of peanuts may not be inclined to purchase five pounds for their first purchase.

Continuing with the foregoing example, the user enters a value of 20% in Percentage Increment Volume from Occasional Users 56 because occasional users are likely to invest in a larger sized bag of peanuts. Under Share of Switchers from Size Switchers 58, the user enters a value of 20% because users who typically purchase large cans of peanuts may be less likely to purchase a large, five pound bag of individually wrapped peanuts. Under Share of Switchers from Brand Switchers 60, the user enters a value of 20% and for Competitive Brand Switchers 62, the user enters a value of 15% because people are more loyal to competitive brands of peanuts than for types within a single brand of peanuts. For Switchers From Price Buyers 64, the user enters a value of 45% because, given a product such as peanuts, price can have a high influence on consumers. Finally, the Percentage Sales from Chain Switchers 66 is given a low value of 10% because, in the user's estimation, peanuts are the type of product that do not motivate buyers to switch from their usual store chains to purchase.

Continuing with the foregoing example, after the promotion is complete the user submits the entries into baseline modifying system 10 and is presented with Main Menu 32. The user enters a new promotion and submits a value of 2,225 for Incremental Brand/Size Consumption 90, representing the actual number of bags of peanuts sold. The user enters a value of 1,000 for Forward Buying 92, and a value of 100 for Base Consumer Franchise 94 for essentially the same reasons as given above. Thereafter, the baseline is modified and reports as previously described with respect to FIGS. 10-16 are generated.

Although the present invention has been described in terms of a web-based method, other embodiments are possible. It is not necessary to use an electronic network such as the Internet.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for generating a modified sales baseline for a product, said method comprising:
storing an original baseline;
receiving a plurality of consumer purchasing characteristics, each of said consumer purchasing characteristics representing a behavior of consumers with respect to said product;
receiving promotion information, said promotion information including quantities of said product sold during a promotion of said product; and
modifying said original baseline in response to said consumer purchasing characteristics and said promotion information.

2. The method of claim 1, further comprising outputting said modified baseline to at least one of a display screen and a printing device.

3. The method of claim 1, wherein said modifying step comprises identifying contributions of each said consumer purchasing characteristic to each said product sold over said baseline during said promotion.

4. The method of claim 3, further comprising outputting said contribution of said consumer product characteristics to at least one of a display screen and a printing device.

5. The method of claim 1, wherein said modifying step comprises identifying quantities of said product sold over said baseline as at least one of incremental consumption and pantry loading.

6. The method of claim 1, wherein said consumer purchasing characteristics include purchasing in response to at least one of brand name, size, and price of said product.

7. The method of claim 1, wherein said consumer purchasing characteristics include purchasing in response to at least one of weight, shelf-life, and packaging of said product.

8. The method of claim 1, wherein said consumer purchasing characteristics include purchasing in response to at least one of population trends, fashion trends and economic forecasts.

9. The method of claim 1, further comprising adjusting said received consumer purchase characteristics in response to increased familiarity with at least one of said consumer purchase characteristics and said product.

10. The method of claim 1, wherein said promotion information further includes estimated quantities of said product purchased for forward buying by a store chain.

11. The method of claim 1, wherein said promotion information further includes estimated quantities of said product purchased for base consumer consumption by a store chain.

12. A system to generate a modified sales baseline for a product, said system comprising:
a database storing an original sales baseline;
a first software facility receiving a plurality of consumer purchasing characteristics, each of said consumer purchasing characteristics representing a behavior of consumers with respect to said product;
a second software facility receiving promotion information, said promotion information including quantities of said product sold during a promotion of said product; and
a third software facility using said consumer purchasing characteristics and said promotion information to modify said original sales baseline.

13. The system of claim 12, further comprising at least one of a display screen and a printing device receiving and outputting said modified sales baseline.

14. The system of claim 12, wherein said third software facility identifies contributions of each said consumer purchasing characteristic to each said product sold over said baseline during said promotion.

15. The system of claim 14, further comprising at least one of a display screen and a printing device receiving and outputting said contributions of said consumer purchasing characteristics to each said product sold over said baseline during said promotion.

16. The system of claim 12, wherein said third software facility identifies quantities of said product sold over said baseline as at least one of incremental consumption and pantry loading.

17. The system of claim 12, wherein said consumer purchasing characteristics include purchasing in response to at least one of brand name, size, and price of said product.

18. The system of claim 12, wherein said consumer purchasing characteristics include purchasing in response to at least one of weight, shelf-life, and packaging of said product.

19. The system of claim 12, wherein said received consumer purchase characteristics are adjusted in response to increased familiarity with at least one of said consumer purchase characteristics and said product.

20. The system of claim 12, wherein said promotion information further includes estimated quantities of said product purchased for base consumer consumption by a store chain.
